(19) United States
(12) Patent Application Publication
(10) Pub. No.: US 2023/0067829 A1
(43) Pub. Date: Mar. 2, 2023

(54) TRANSMISSION ASSEMBLY FOR AN ENGINE WITH A CONDUIT SYSTEM HAVING TWO FLUID GUIDES ON A STATIC PART

(71) Applicant: Rolls-Royce Deutschland Ltd & Co KG, Blankenfelde-Mahlow (DE)

(72) Inventors: Thomas PROBERT, Berlin (DE); Jakob VIOLET, Nuthetal (DE)

(21) Appl. No.: 17/895,742

(22) Filed: Aug. 25, 2022

(30) Foreign Application Priority Data
Aug. 27, 2021 (DE) 10 2021 209 456.2

(51) Int. Cl. F01D 9/06; F01D 25/12; F01D 25/18; F02C 7/36

(52) U.S. Cl. CPC F01D 9/06; F01D 25/125; F01D 25/18; F02C 7/36; F05D 2240/54; F05D 2260/40311; F05D 2260/232; F05D 2260/60; F05D 2260/98

(57) ABSTRACT

The proposed solution relates to a gear box assembly for an engine, having
a gear box for transmitting a torque,
at least one first, static part,
at least one second, rotating part, which is mounted so as to be rotatable relative to the first, static part and on which at least one element of the gear box is provided, and
a conduit system for conveying a fluid to elements of the gear box.

A feed device of the conduit system on the first, static part has at least two separate fluid guides, of which a first fluid guide is provided for guiding fluid from at least one first feed opening to a first supply line in the second, rotating part and a second fluid guide is provided for guiding fluid from at least one second feed opening to a second supply line in the second, rotating part.

This application claims priority to German Patent Application 102021209456.2 filed Aug. 27, 2021, the entirety of which is incorporated by reference herein.

The proposed solution relates to a gear box assembly for an engine.

The prior art, for example DE 10 2017 108 332 A1, has already disclosed a gear box assembly having a gear box by means of which a torque can be transmitted from a low-pressure turbine to a fan of an engine. Here, during the operation of the engine, a core shaft is coupled by means of the gear box of the gear box assembly to the fan of the engine such that the fan rotates at a lower rotational speed than the core shaft. Such a gear box is subjected to extremely high rotational speeds during operation, such that adequate lubrication and cooling of elements of the gear box must be ensured.

It is furthermore known from practice for fluid to be conducted into different regions of the gear box, and thus to different elements of the gear box, via a conduit system. For this purpose, the conduit system comprises at least one first supply line in a second, rotating part (which rotates during the operation of the gear box) on which rotatable elements of the gear box are provided. The first supply line then serves for conveying fluid to a first region of the gear box. Fluid is conveyed to another, second region of the gear box by means of at least one further, second supply line in the second, rotating part. It is thus for example the case that, during the operation of the engine, by means of a central oil reservoir, oil is conveyed via the conduit system to bearings and toothed gear pairings of the gear box. The different supply lines in the second, rotating part are supplied with fluid by a feed device of the conduit system. This feed device is provided in a first, static part, relative to which the second, rotating part rotates during the operation of the gear box. Fluid is guided to the individual supply lines by means of the feed device.

A disadvantage in this context is the relatively low possibility of controlling the fluid flow in the individual supply lines. For example, a central feed device has hitherto typically been provided, by means of which fluid is guided from a central reservoir to the different supply lines. Here, in each case one individual region of the gear box then determines individual specifications under which the fluid is also conveyed to the other regions. If, for example, the fluid may be present with a maximum temperature of 120° C. in one region but only with a maximum temperature of 100° C. in another region, the fluid is in principle provided via the conduit system with a maximum temperature of 100° C.

Against this background, the proposed solution is based on the object of further improving a gear box assembly having a gear box for an engine, and of allowing greater flexibilization in particular with regard to the supply of fluid to different regions of the gear box via one conduit system.

This object is achieved by means of a gear box assembly according to claim 1.

Here, a proposed gear box assembly comprises, as part of a conduit system for conveying a fluid to at least two different regions of a gear box, a feed device with at least two separate fluid guides. Here, a first fluid guide of the at least two separate fluid guides is provided for guiding fluid from at least one first feed opening to a first supply line, whereas a second fluid guide of the at least two separate guides is provided for guiding fluid from at least one (other) second feed opening to a second supply line. Here, the supply lines are likewise part of the conduit system and are arranged in a second, rotating part of the gear box assembly, on which at least one element of the gear box is provided. The feed device is in turn provided on a first, static part, relative to which the second, rotating part is mounted so as to be rotatable.

The proposed solution is based on the underlying concept of using a feed device with at least two separate fluid guides on the first, static part to realize a spatial separation between different fluid flows that are to be conducted to the two different connecting lines, by virtue of said fluid flows being fed in at different first and second feed openings and being guided via different fluid guides of the feed device to the second, rotating part. It is thus possible in a particularly simple manner for different regions of the gear box to be supplied with fluids that differ at least to some extent or at least with fluid with physical characteristics that differ according to the volume line (such as different conveying pressure, different (flow) speed and/or different temperature). It is thus possible, on one gear box, for different (gear box) elements to be supplied differently with fluid, even if exactly one central fluid reservoir is provided for the fluid. By means of the feed device, a separation of fluid flows can be realized, which allows the different regions of the gear box to be supplied differently with fluid.

The at least two fluid guides may be provided for guiding different fluids. The first fluid guide to the first supply line can thus be provided for guiding a first type of fluid, whereas the second fluid guide to the second supply line is provided for a second type of fluid. The different types of fluids differ here for example with regard to the chemical characteristics, for example also with regard to the composition of the fluids. It is also possible here for a conveying pressure, speed and/or temperature of the fluids to differ from one another according to the fluid guide.

In an alternative design variant, the at least two fluid guides are provided for guiding a fluid with different delivery pressures, speeds and/or temperatures. In this design variant, the conduit system is consequently fed with exactly one type of fluid, and has for example a common fluid reservoir for both supply lines. Two fluid guides are however provided by means of the feed device in order to provide the fluid with a different conveying pressure, a different (flow) speed and/or with a different temperature depending on the supply line.

Each fluid guide may for example have at least one guide duct for the fluid that is to be guided to the respective supply line. Here, a guide duct is to be understood for example to mean inter alia a duct of ring-shaped and/or gap-shaped cross section on the first, static part.

In one design variant, the at least one guide duct extends in each case axially in relation to a rotation axis of the second, rotating part. Consequently, in relation to a conveying or flow path of the fluid that is to be guided in the respective fluid guide, the respective guide duct bridges a certain axial component.

In one design variant, in order to facilitate a transfer of the fluid from the first, static part to the different supply lines in the second, rotating part, a guide duct of the first fluid guide and a guide duct of the second fluid guide have different lengths. Here, by means of different lengths of the guide ducts, it is not only possible for flow characteristics of the fluid that is guided in a guide duct to be controlled. Rather, by means of different lengths, it is also possible to specify the locations at which a transfer of the fluid takes place from the first, static part to the second, rotating part.

For a compact design of the feed device, provision may be made whereby the feed device has a feed duct component on which both at least one guide duct of the first fluid guide and at least one guide duct of the second fluid guide are formed. It is thus the case that fluid ducts of both fluid guides are formed on a single fluid duct component of the feed device, but also remain spatially separated from one another on the fluid duct component.

For example, guide ducts of the at least two different fluid guides are arranged so as to alternate with one another along a circumferential direction on the fluid duct component. It is thus for example the case that guide ducts of the first and second fluid guides alternate over a circumference of the fluid duct component, and in this case in particular along a circumferential direction about the rotation axis of the second, rotating part. Here, the guide ducts may in particular also be distributed uniformly along the circumferential direction.

In one design variant, the first fluid guide has at least two guide ducts, to which the at least one feed opening is assigned. Alternatively or in addition, the second fluid guide has at least two guide ducts, to which the at least one second feed opening is assigned. In the above-stated variants, it is thus the case that in each case at least one feed opening is assigned to at least two guide ducts of a particular fluid guide in order to be able to feed fluid via the respective feed opening to multiple (at least two) associated guide ducts. This encompasses a situation in which exactly one feed opening is assigned to in each case at least two guide ducts. If appropriate, it is however also possible for multiple feed openings to be assigned to at least two guide ducts. Here, a number of feed openings may also be assigned to a different number of guide ducts.

In one design variant, the distribution of fluid from one feed opening to multiple guide ducts is facilitated by means of a distributor component of the feed device. By means of such a distributor component, a fluid flow from the at least one first feed opening and/or a fluid flow from the at least one second feed opening can be divided up into multiple partial flows to the respectively assigned guide ducts. This encompasses in particular a situation in which a fluid flow from exactly one single first feed opening for fluid to the first supply line is divided up by means of the distributor component into multiple partial fluid flows to individual guide ducts. Here, provision may also be made whereby a (further) fluid flow that is provided via exactly one single second feed opening is also divided up by means of one and the same distributor component.

For example, the distributor component has at least two distributor openings via which fluid from a fluid flow can be guided to the at least two guide ducts. Here, the number of distributor openings for a fluid guide then corresponds to the number of guide ducts of the corresponding fluid guide. A distributor opening of the distributor component thus leads to exactly one guide duct. In one design variant, there are thus for example six distributor openings formed on the distributor component for six guide ducts of a fluid guide.

In one design variant, the feed device is of multi-part form and is formed in particular with a housing part and a distributor component. The at least one first feed opening is then provided on the housing part. Together with the distributor component, the housing part defines a distributor duct which runs in circumferentially encircling fashion in relation to the rotation axis of the second, rotating part and into which fluid can flow from the at least one first feed opening and from which the inflowing fluid can flow via the at least two distributor openings into the at least two guide ducts of the first fluid guide. Fluid that is fed in at the feed opening is thus divided up between the different guide ducts of a fluid guide by means of the distributor duct. For the different fluid guides, it is accordingly possible for a corresponding number of distributor ducts to be formed. Consequently, a second distributor duct is provided for a second guide duct.

Through the use of a distributor duct, the fluid flow can be homogenized over the circumference of the distributor component. In one design variant, the distributor component is for example arranged radially at the inside in relation to the housing part, such that the housing part, at least in the region of the distributor duct, receives and thus circumferentially fully encloses the distributor component. Here, in turn, a guide duct component, in particular a sleeve-shaped guide duct component, may be provided, on the outer lateral surface of which the at least two guide ducts are formed and which in turn is received at least in certain portions in the tubular distributor component. In this way, fluid originating from a distributor opening can pass into an assigned guide duct of the fluid duct component and be conveyed onward (axially) in the direction of an outflow opening, and via this to the respective supply line.

In principle, on the distributor component, there may be provided at least one outflow opening via which fluid can flow from the respective guide duct to the assigned first or second supply line. Consequently, during the operation of the gear box, fluid is guided in the guide duct component between an associated distributor opening and an outflow opening on the distributor component.

Instead of assigning at least one feed opening to at least two guide ducts, one design variant provides an assignment of one guide duct of one fluid guide to exactly one feed opening. A fluid flow fed in via a feed opening is thus guided only into exactly one associated guide duct, without the fluid flow being divided up. Such a configuration may for example also be implemented with a single-part guide duct component. In particular, for this purpose, a guide duct component manufactured by additive processes may be provided, on which not only the individual guide ducts for the different first and second supply lines but also the feed openings and outflow openings are formed. Additional functions, which are divided up between different components in the design variant discussed above with a single housing part and a distributor component, are thus integrated in a guide duct component of said type.

In principle, a guide duct may be assigned in each case one outflow opening of the feed device, via which fluid can flow from the respective guide duct to the assigned first or second supply line. This encompasses in particular a situation in which multiple outflow openings are also assigned to exactly one duct portion that circumferentially encircles the second, rotating part, which duct portion is then part either of the first supply line or of the second supply line. It is thus possible for fluid from the first, static part to be conveyed onward into the appropriate duct portion of the second, rotating part via multiple outflow openings of the first fluid guide or of the second fluid guide. Here, for example, a region, through which flow passes radially, between the outflow openings and the respective duct portion of the first or second supply line is axially sealed off such that no leakage or at least no significant leakage occurs as the fluid flows from the first, static part into the second, rotating part.

An outflow opening of the first fluid guide may be axially offset with respect to an outflow opening of the second fluid guide in relation to the rotation axis of the second, rotating part. Thus, the outflow openings of the first and second fluid guides can also be more easily assigned to axially mutually offset duct portions of the first and second supply lines on the second, rotating part.

The first feed opening of the first fluid guide and the second feed opening of the second fluid guide may in principle be positioned offset with respect to one another axially, and/or along a circumferential direction (about the rotation axis), in relation to the rotation axis of the second, rotating part. A corresponding offset facilitates in particular the assembly process and the connection of fluid conduits to the feed openings.

A feed opening may if appropriate be provided on a radially protruding projection of the feed device in order to facilitate the connection of a fluid conduit thereto.

The fluid conduits for the different first and second feed openings may be connected to a common fluid reservoir. As already discussed above, it is however then possible for the fluid conduits for the different first and second feed openings to be connected to different parts, in particular to different circuits of the conduit system, in order to provide fluid flows with different conveying pressures, speeds and/or temperatures in the first and second supply lines.

In one design variant, the first supply line is provided for conveying the fluid to a bearing, in particular a plain bearing of the gear box, whereas the second supply line is provided for conveying the fluid to a toothed gear pairing of the gear box. In both cases, the fluid can serve for lubrication and/or dissipation of heat at the respective region of the gear box. In view of the different requirements in the respective region, it is however possible by means of the proposed solution for the respective fluid flow in the first and second supply lines to be adapted, in particular with regard to the temperature of the fluid flowing therein, in a variable manner and in particular independently of the other supply line.

For example, the gear box is configured as a planetary gear box. In this context, provision may for example be made whereby the conduit system is part of an oil supply for a planet carrier of the planetary gear box. The fluid to be conveyed is thus for example an oil, and in this case in particular an oil for lubrication and/or dissipation of heat at a planet carrier of the planetary gear box. This encompasses, for example, a situation in which the first supply line is provided for conveying the fluid to a bearing by means of which a planet gear of the planetary gear box is rotatably mounted on the planet carrier, and the second supply line is provided for conveying the fluid to a toothed gear pairing between a planet gear and a sun gear of the planetary gear box. In this context, it may for example be advantageous to provide fluid flows with different temperatures for the two supply lines. In this way, in relation to previous gear box assemblies, it is possible to provide (more) targeted control of the thermal expansion at elements of the gear box during the operation of the gear box. If, for example, relatively cool fluid is conducted to a plain bearing of the planet gear and thus relatively warm fluid is conducted to the toothed gear pairing, a greater expansion of the planet gear in relation to a bearing journal of the plain bearing occurs in relation to previous solutions. This can in turn lead to a greater fluid gap at the plain bearing, and thus more space for lubricating fluid. It is thus possible for a larger, more stable plain bearing film to be generated by means of the fluid at the plain bearing.

The proposed solution furthermore relates to an engine having a design variant of a proposed gear box assembly. This encompasses, in particular, an engine which has at least one core engine and one fan. The core engine then comprises a turbine, a compressor and a core shaft that connects the turbine to the compressor, wherein the fan is positioned upstream of the core engine and comprises multiple fan blades. The gear box of the gear box assembly can be driven by the core shaft in order to drive the fan at a lower rotational speed than the core shaft by means of the gear box.

As noted elsewhere herein, the present disclosure may relate to a gas turbine engine, for example an aircraft engine. Such a gas turbine engine may comprise a core engine comprising a turbine, a combustor, a compressor, and a core shaft connecting the turbine to the compressor. Such a gas turbine engine may comprise a fan (with fan blades) which is positioned upstream of the core engine.

Arrangements of the present disclosure may be advantageous in particular, but not exclusively, for geared fans, which are driven via a gear box. Accordingly, the gas turbine engine may comprise a gear box which is driven via the core shaft and whose output drives the fan in such a way that it has a lower rotational speed than the core shaft. The input to the gear box may be provided directly from the core shaft, or indirectly via the core shaft, for example via a spur shaft and/or spur gear. The core shaft may be connected rigidly to the turbine and the compressor, such that the turbine and compressor rotate at the same rotational speed (with the fan rotating at a lower rotational speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may furthermore comprise a second turbine, a second compressor, and a second core shaft, which connects the second turbine to the second compressor. The second turbine, the second compressor and the second core shaft may be arranged so as to rotate at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The gear box may be designed to be driven by the core shaft that is configured to rotate (for example during use) at the lowest rotational speed (for example the first core shaft in the example above). For example, the gear box may be designed to be driven only by the core shaft that is configured to rotate (for example during use) at the lowest rotational speed (for example only by the first core shaft and not by the second core shaft, in the example above). Alternatively, the gear box may be designed to be driven by one or more shafts, for example the first and/or second shaft in the example above.

In a gas turbine engine as described and/or claimed herein, a combustor may be provided axially downstream of the fan and compressor (or compressors). For example, the combustor may be directly downstream of (for example at the exit of) the second compressor, if a second compressor is provided. By way of a further example, the flow at the exit of the compressor may be fed to the inlet of the second turbine, when a second turbine is provided. The combustor may be provided upstream of the turbine(s).

The or each compressor (for example the first compressor and the second compressor as described above) may comprise any number of stages, for example multiple stages. Each stage may comprise a series of rotor blades and a series of stator blades, which may be variable stator blades (that is to say the angle of attack may be variable). The series of rotor blades and the series of stator blades may be axially offset from one another.

The or each turbine (for example the first turbine and the second turbine as described above) may comprise any number of stages, for example multiple stages. Each stage may comprise a row of rotor blades and a row of stator blades. The series of rotor blades and the series of stator blades may be axially offset from one another.

Each fan blade may have a radial span extending from a root (or a hub) at a radially inner location over which gas flows, or from a span position of 0%, to a tip at a span position of 100%. The ratio of the radius of the fan blade at the hub to the radius of the fan blade at the tip may be less than (or of the order of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in a closed interval delimited by two values in the previous sentence (that is to say the values may form upper or lower limits). These ratios can commonly be referred to as the hub-to-tip ratio. The radius at the hub and the radius at the tip may both be measured at the leading edge (or the axially forwardmost edge) of the blade. The hub-to-tip ratio refers, of course, to that portion of the fan blade over which gas flows, i.e. the portion radially outside any platform.

The radius of the fan may be measured between the engine centreline and the tip of the fan blade at its leading edge. The diameter of the fan (which can generally be double the radius of the fan) may be larger than (or of the order of): 250 cm (approximately 100 inches), 260 cm (approximately 103 inches), 270 cm (approximately 105 inches), 280 cm (approximately 110 inches), 290 cm (approximately 115 inches), 300 cm (approximately 120 inches), 310 cm (approximately 123 inches), 320 cm (approximately 125 inches), 330 cm (approximately 130 inches), 340 cm (approximately 135 inches), 350 cm (approximately 139 inches), 360 cm (approximately 140 inches), 370 cm (approximately 145 inches), 380 cm (approximately 150 inches) or 390 cm (approximately 155 inches). The fan diameter may be in a closed interval delimited by two of the values in the previous sentence (i.e. the values may form upper or lower limits).

The rotational speed of the fan may vary in operation. Generally, the rotational speed is lower for fans with a larger diameter. Purely as a non-limiting example, the rotational speed of the fan under cruise conditions may be less than 2500 rpm, for example less than 2300 rpm. Purely by way of a further non-limiting example, the rotational speed of the fan under cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of a further non-limiting example, the rotational speed of the fan under cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

During the use of the gas turbine engine, the fan (with associated fan blades) rotates about a rotation axis. This rotation results in the tip of the fan blade moving with a speed Uₜᵢₚ. The work done by the fan blades on the flow results in an enthalpy rise dH of the flow. A fan tip loading may be defined as dH/Uₜᵢₚ², where dH is the enthalpy rise (for example the average 1-D enthalpy rise) across the fan and Uₜᵢₚ is the (translational) speed of the fan tip, for example at the leading edge of the tip (which can be defined as fan tip radius at the leading periphery multiplied by angular velocity). The fan tip loading under cruise conditions may be more than (or of the order of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in a closed interval delimited by any two of the values in the previous sentence (that is to say the values may form upper or lower limits).

Gas turbine engines in accordance with the present disclosure may have any desired bypass ratio, wherein the bypass ratio is defined as the ratio of the mass flow rate of the flow through the bypass duct to the mass flow rate of the flow through the core under cruise conditions. In the case of some arrangements, the bypass ratio can be more than (or of the order of): 10, 10.5, 11, 11.5, 12, 12.5, 13, 13.5, 14, 14.5, 15, 15.5, 16, 16.5, or 17. The bypass ratio may be in a closed interval delimited by two of the values in the previous sentence (that is to say the values may form upper or lower limits). The bypass duct may be substantially annular. The bypass duct may be situated radially outside the core engine. The radially outer surface of the bypass duct may be defined by an engine nacelle and/or a fan casing.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of a non-limiting example, the overall pressure ratio of a gas turbine engine as described and/or claimed herein at cruising speed may be greater than (or of the order of): 35, 40, 45, 50, 55, 60, 65, 70, 75. The overall pressure ratio may be in a closed interval delimited by two of the values in the previous sentence (that is to say the values may form upper or lower limits).

The specific thrust of an engine may be defined as the net thrust of the engine divided by the total mass flow through the engine. The specific thrust of an engine as described and/or claimed herein under cruise conditions may be less than (or of the order of): 110 Nkg⁻¹ s, 105 Nkg⁻¹ s, 100 Nkg⁻¹ s, 95 Nkg⁻¹ s, 90 Nkg⁻¹ s, 85 Nkg⁻¹ s or 80 Nkg⁻¹ s. The specific thrust may be in a closed interval delimited by two of the values in the previous sentence (that is to say the values may form upper or lower limits). Such engines can be particularly efficient in comparison with conventional gas turbine engines.

A gas turbine engine as described and/or claimed herein may have any desired maximum thrust. Purely as a non-limiting example, a gas turbine as described and/or claimed herein may be capable of generating a maximum thrust of at least (or of the order of): 160 kN, 170 kN, 180 kN, 190 kN, 200 kN, 250 kN, 300 kN, 350 kN, 400 kN, 450 kN, 500 kN or 550 kN. The maximum thrust may be in a closed interval delimited by two of the values in the previous sentence (that is to say the values may form upper or lower limits). The thrust referred to above may be the maximum net thrust under standard atmospheric conditions at sea level plus 15° C. (ambient pressure 101.3 kPa, temperature 30° C.), with the engine static.

During use, the temperature of the flow at the entry to the high-pressure turbine can be particularly high. This temperature, which may be referred to as TET, may be measured at the exit to the combustor, for example directly upstream of the first turbine blade, which in turn may be referred to as a nozzle guide blade. At cruising speed, the TET may be at least (or of the order of): 1400 K, 1450 K, 1500 K, 1550 K, 1600 K or 1650 K. The TET at cruising speed may be in a closed interval delimited by two of the values in the previous sentence (that is to say the values may form upper or lower limits). The maximum TET during use of the engine may for example be at least (or of the order of): 1700 K, 1750 K, 1800 K, 1850 K, 1900 K, 1950 K or 2000 K. The maximum TET may be in a closed interval delimited by two of the values in the previous sentence (that is to say the values may form upper or lower limits). The maximum TET may occur, for example, under a high thrust condition, for example under a maximum take-off thrust (MTO) condition.

A fan blade and/or an aerofoil portion of a fan blade as described and/or claimed herein may be produced from any suitable material or a combination of materials. For example, at least a part of the fan blade and/or of the aerofoil may be produced at least in part from a composite, for example a metal matrix composite and/or an organic matrix composite, such as carbon fibre. By way of further example, at least a part of the fan blade and/or of the aerofoil may be produced at least in part from a metal, such as for example a titanium-based metal or an aluminium-based material (such as for example an aluminium-lithium alloy) or a steel-based material. The fan blade may comprise at least two regions produced using different materials. For example, the fan blade may have a protective leading edge, which is produced using a material that is better able to resist impact (for example from birds, ice or other material) than the rest of the blade. Such a leading edge may, for example, be produced using titanium or a titanium-based alloy. Thus, purely by way of example, the fan blade may have a carbon-fibre-based or aluminium-based body (such as an aluminium-lithium alloy) with a titanium leading periphery.

A fan as described and/or claimed herein may comprise a central portion from which the fan blades can extend, for example in a radial direction. The fan blades may be attached to the central portion in any desired manner. For example, each fan blade may comprise a fixture device which can engage with a corresponding slot in the hub (or disk). Purely as an example, such a fixture may be in the form of a dovetail that may slot into and/or be brought into engagement with a corresponding slot in the hub/disk in order to fix the fan blade to the hub/disk. By way of further example, the fan blades may be formed integrally with a central portion. Such an arrangement may be referred to as a blisk or a bling. Any suitable method may be used to produce such a blisk or such a bling. For example, at least some of the fan blades may be machined from a block and/or at least some of the fan blades may be attached to the hub/disk by welding, such as e.g. linear friction welding.

The gas turbine engines as described and/or claimed herein may or may not be provided with a variable area nozzle (VAN). Such a variable area nozzle can allow the exit cross section of the bypass duct to be varied during operation. The general principles of the present disclosure can apply to engines with or without a VAN.

The fan of a gas turbine as described and/or claimed herein may have any desired number of fan blades, for example 16, 18, 20, or 22 fan blades.

As used herein, cruise conditions may mean the cruise conditions of an aircraft to which the gas turbine engine is attached. Such cruise conditions can be conventionally defined as the conditions during the middle part of the flight, for example the conditions experienced by the aircraft and/or the engine between (in terms of time and/or distance) the top of climb and the start of descent.

Purely by way of an example, the forward speed under the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of Mach 0.8, of the order of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example of the order of 11000 m. The cruise conditions may correspond to standard atmospheric conditions at any given altitude in these ranges.

Purely by way of example, the cruise conditions may correspond to the following: a forward Mach number of 0.8, a pressure of 23000 Pa and a temperature of −55° C.

As used anywhere herein, “cruising speed” or “cruise conditions” may mean the aerodynamic design point. Such an aerodynamic design point (or ADP) may correspond to the conditions (including, for example, the Mach number, ambient conditions and thrust requirement) for which the fan operation is designed. This may mean, for example, the conditions under which the fan (or gas turbine engine) has the optimum efficiency in terms of construction.

During operation, a gas turbine engine as described and/or claimed herein can operate under the cruise conditions defined elsewhere herein. Such cruise conditions may be determined by the cruise conditions (for example the conditions during the middle part of the flight) of an aircraft on which at least one (for example two or four) gas turbine engine(s) may be mounted in order to provide propulsive thrust.

It is self-evident to a person skilled in the art that a feature or parameter described in relation to one of the above aspects may be applied to any other aspect, unless these are mutually exclusive. Furthermore, any feature or any parameter described here may be applied to any aspect and/or combined with any other feature or parameter described here, unless these are mutually exclusive.

The appended figures illustrate, by way of example, possible design variants of the proposed solution.

In the figures:

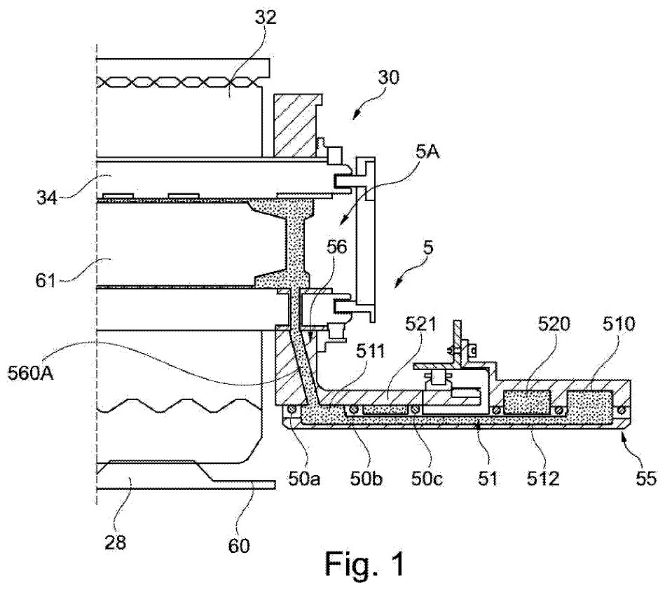

FIG. 1 shows, in a detail, a design variant of a proposed gear box assembly in cross section and in a view directed towards a first supply line within a second, rotating part, on which elements of the gear box are provided, of the gear box assembly, and towards a first fluid guide of a feed device in a first, static part of the gear box assembly;

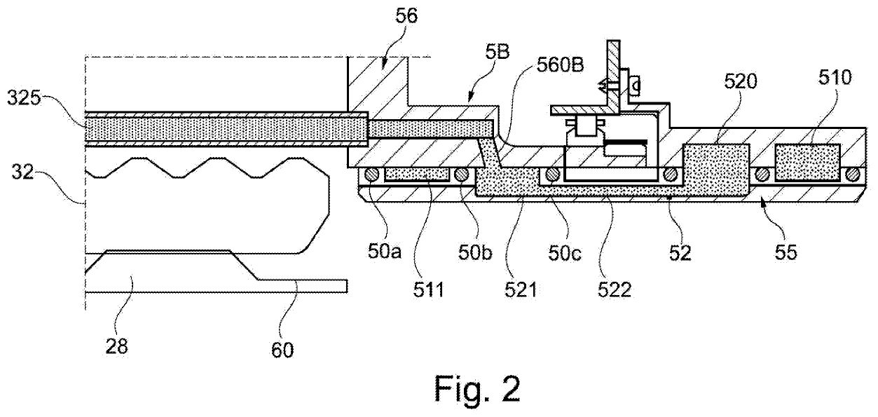

FIG. 2 shows, likewise in a detail and in cross section, the gear box assembly of FIG. 1 in a view directed towards a second supply line and a second fluid guide of the feed device;

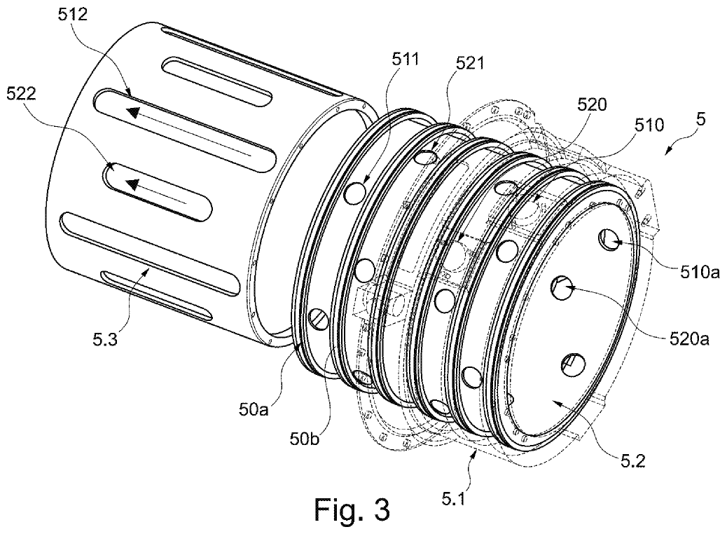

FIG. 3 shows, in an exploded illustration, parts of the feed device of FIGS. 1 and 2 for the spatial separation of the fluid flow, which feeds the first and second supply lines, in the first, static part;

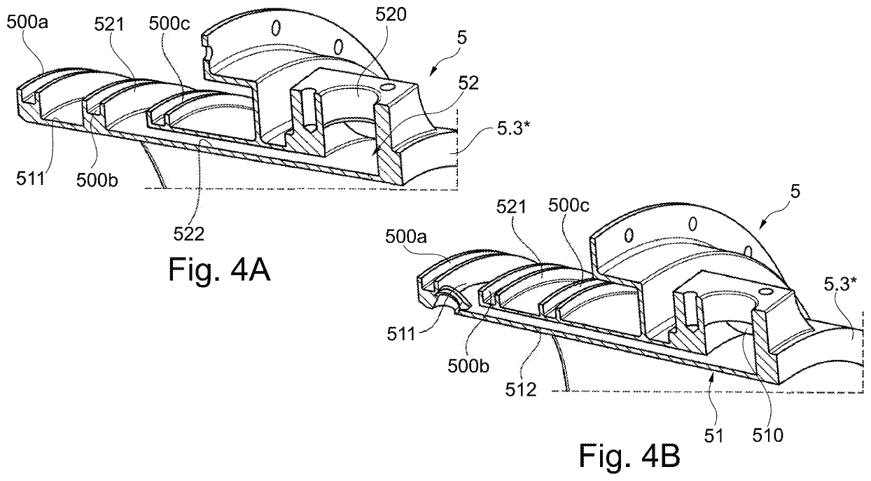

FIGS. 4A-4B show, in different sectional views, a further design variant of a feed device for a gear box assembly of FIGS. 1 and 2, wherein the feed device is formed here with a single-part guide duct component, which also integrates feed openings and outflow openings;

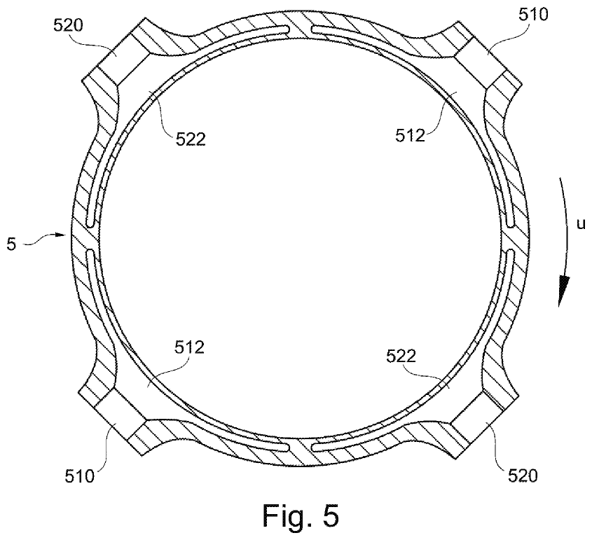

FIG. 5 shows a cross-sectional view of the guide duct component of FIGS. 4A and 4B;

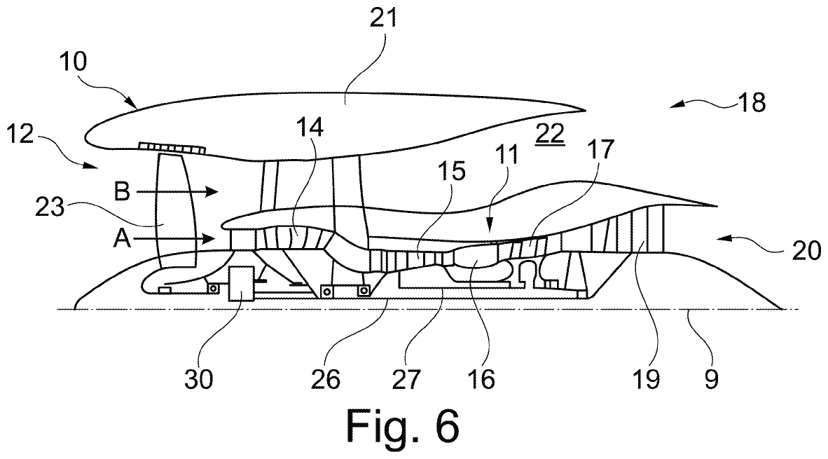

FIG. 6 shows a lateral sectional view of a gas turbine engine in which a proposed gear box assembly is used;

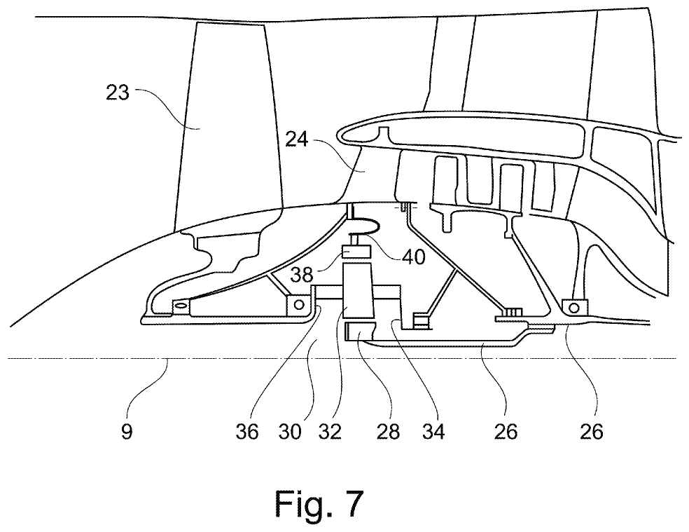

FIG. 7 shows a close-up lateral sectional view of an upstream portion of a gas turbine engine of FIG. 6;

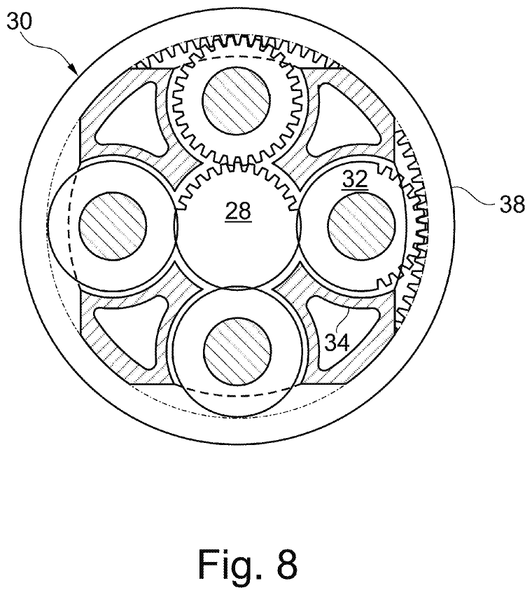

FIG. 8 shows a partially cut-away view of a gear box for a gas turbine engine of FIGS. 6 and 7.

Before design variants of a proposed gear box assembly having a feed device 5 are described in more detail, a field of application of the proposed solution, namely a gas turbine engine 10 of an aircraft, will be described in conjunction with FIGS. 6 to 8.

FIG. 6 illustrates a gas turbine engine 10 having a main rotation axis 9. The engine 10 comprises an air intake 12 and a fan 23 that generates two air flows: a core air flow A and a bypass air flow B. The gas turbine engine 10 comprises a core 11 that receives the core air flow A. When viewed in the order corresponding to the axial direction of flow, the core engine 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 via a shaft 26 and an epicyclic planetary gear box 30.

During operation, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and low-pressure turbines 17, 19 and thereby drive said turbines, before being expelled through the nozzle 20 to provide a certain thrust force. The high-pressure turbine 17 drives the high-pressure compressor 15 by way of a suitable connecting shaft 27. The fan 23 generally provides the major part of the thrust force. The epicyclic planetary gear box 30 is a reduction gear box.

An exemplary arrangement for a geared fan gas turbine engine 10 is shown in FIG. 6. The low-pressure turbine 19 (see FIG. 6) drives the shaft 26, which is coupled to a sun gear 28 of the epicyclic planetary gear box 30. Multiple planet gears 32, which are coupled to one another by a planet carrier 34, are situated radially to the outside of the sun gear 28 and mesh therewith. The planet carrier 34 guides the planet gears 32 in such a way that they circulate synchronously around the sun gear 28, whilst enabling each planet gear 32 to rotate about its own axis. The planet carrier 34 is coupled via linkages 36 to the fan 23 in order to drive its rotation about the engine axis 9. An external gear or ring gear 38 that is coupled via linkages 40 to a stationary support structure 24 is situated radially to the outside of the planet gears 32 and meshes therewith.

It should be noted that the expressions “low-pressure turbine” and “low-pressure compressor”, as used herein, can be taken to mean the lowest-pressure turbine stage and lowest-pressure compressor stage (i.e. not including the fan 23), respectively, and/or the turbine and compressor stages that are connected together by the connecting shaft 26 with the lowest rotational speed in the engine (i.e. not including the gear box output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 may be referred to as a first, or lowest-pressure, compression stage.

The epicyclic planetary gear box 30 is shown in greater detail by way of example in FIG. 8. The sun gear 28, planet gears 32 and ring gear 38 in each case comprise teeth on their periphery to allow meshing with the other toothed gears. However, for clarity, only exemplary portions of the teeth are illustrated in FIG. 8. Although four planet gears 32 are illustrated, it will be apparent to a person skilled in the art that more or fewer planet gears 32 may be provided within the scope of protection of the claimed invention. Practical applications of an epicyclic planetary gear box 30 generally comprise at least three planet gears 32.

The epicyclic planetary gear box 30 illustrated by way of example in FIGS. 7 and 8 is a planetary gear box in which the planet carrier 34 is coupled to an output shaft via linkages 36, with the ring gear 38 being fixed. However, any other suitable type of planetary gear box 30 may be used. As a further example, the planetary gear box 30 may be a star arrangement, in which the planet carrier 34 is held fixed, with the ring gear (or external gear) 38 being allowed to rotate. In such an arrangement, the fan 23 is driven by the ring gear 38. As a further alternative example, the gear box 30 may be a differential gear box in which both the ring gear 38 and the planet carrier 34 are allowed to rotate.

It is self-evident that the arrangement shown in FIGS. 7 and 8 is merely an example, and various alternatives fall within the scope of protection of the present disclosure. Purely by way of example, any suitable arrangement can be used for positioning the gear box 30 in the engine 10 and/or for connecting the gear box 30 to the engine 10. By way of a further example, the connections (such as the linkages 36, 40 in the example of FIG. 7) between the gear box 30 and other parts of the engine 10 (such as the input shaft 26, the output shaft and the fixed structure 24) may have a certain degree of stiffness or flexibility. As a further example, any suitable arrangement of the bearings between rotating and stationary parts of the engine 10 (for example between the input and output shafts of the gear box and the fixed structures, such as the gear casing) may be used, and the disclosure is not limited to the exemplary arrangement of FIG. 7. For example, where the gear box 30 has a star arrangement (described above), a person skilled in the art would readily understand that the arrangement of output and support linkages and bearing positions would usually be different from that shown by way of example in FIG. 7.

Accordingly, the present disclosure extends to a gas turbine engine having any arrangement of gear box types (for example star-shaped or epicyclic-planetary), support structures, input and output shaft arrangement, and bearing positions.

Optionally, the gear box may drive additional and/or alternative components (for example the intermediate-pressure compressor and/or a booster compressor).

Other gas turbine engines in which the present disclosure can be used may have alternative configurations. For example, such engines may have an alternative number of compressors and/or turbines and/or an alternative number of connecting shafts. As a further example, the gas turbine engine shown in FIG. 6 has a split flow nozzle 20, 22, meaning that the flow through the bypass duct 22 has its own nozzle, which is separate from and radially outside the engine core nozzle 20. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable region. Although the example described relates to a turbofan engine, the disclosure may be applied for example to any type of gas turbine engine, for example an open-rotor engine (in which the fan stage is not surrounded by an engine nacelle) or a turboprop engine. In some arrangements, the gas turbine engine 10 potentially does not comprise a gear box 30.

The geometry of the gas turbine engine 10, and components thereof, is/are defined by a conventional axis system, which comprises an axial direction (which is aligned with the rotation axis 9), a radial direction (in the direction from bottom to top in FIG. 6), and a circumferential direction (perpendicular to the view in FIG. 6). The axial, radial and circumferential directions are mutually perpendicular.

For lubrication and/or heat dissipation, provision may be made for a friction-releasing and/or cooling fluid, for example oil, to be conveyed to various points of the planetary gear box 30. For example, specifically with regard to the high rotational speeds of rotating (gear box) elements of the planetary gear box 30, provision may be made for oil to be supplied to bearings for these rotating elements and/or to toothed gear pairings at this planetary gear box 30. This relates for example to a plain bearing arrangement for a planet gear 32 on the planet carrier 34. Here, in order to provide the greatest possible degree of fail safety, a conduit system for conveying oil to a corresponding plain bearing is provided. In the present case, a planet gear 32 rotates, at the respective plain bearing, in each case about a journal 61 of the planetary gear box 30. This journal 61 is illustrated as a detail in FIG. 1 together with a sun gear 28 of the planetary gear box 30. The sun gear 28 of the planetary gear box 30 can be driven via a drive shaft 60.

FIG. 1 shows further parts of a conduit system, which in the present case comprises inter alia a feed device 5 and a first supply line 5A to the bearings, configured here in the form of plain bearings, at the planet carrier 34. Here, the conduit system 5 of FIG. 1 is part of a design variant of a proposed gear box assembly which comprises a first, static part 55 and a second part 56, which is mounted so as to be rotatable relative to said first part and which rotates during the operation of the planetary gear box 30 and on which the planet carrier 34 is provided. Oil, which originates for example from a central oil reservoir, is conducted via the feed device 5 in the first, static part 55 to the second, rotating part 56 and is transferred at various points of the second, rotating part 56 to duct portions 560A and 560B (cf. also FIG. 2) that belong to different supply lines 5A and 5B. Whilst the first supply line 5A is provided for conveying oil to the plain bearings of the planet carrier 34, a second supply line 5B serves for conveying oil to the planet gears 32, and here in each case to a nozzle holder 325 between two planet gears 32, for the purposes of lubricating the toothed gear pairing between a respective planet gear 32 and the sun gear 28. In order to make it possible here to supply oil at different temperatures, for example, to the supply lines 5A, 5B that are provided for supplying oil to different regions of the gear box 30, the feed device 5 has two fluid guides 51, 52 in the first, static part 55.

The first fluid guide 51, which can be seen in the cross-sectional view of FIG. 1, has a single feed opening 510 for the connection of one fluid conduit. Via this (first) feed opening 510 of the first fluid guide 51, the oil passes via an axially extending fluid duct 512 that opens into an outflow opening 511 of the first fluid guide 51. Via this outflow opening 511, the oil can flow into the duct portion 560A, which is part of the first supply line 5A, in the second, rotating part 56. At the transition between the outflow opening 511 of the first fluid guide 51 and the duct portion 560A of the first supply line 5A, a seal with respect to the second, rotating part 56 is provided by way of seals 50a, 50b in the form of circumferentially encircling sealing rings.

Additionally, correspondingly to the cross-sectional view of FIG. 2, the feed device 5 also incorporates a second fluid guide 52, via which oil can be conducted to the second supply line 5B. For this purpose, the second fluid guide 52 has a second feed opening 520, which is axially offset with respect to the first feed opening 510 of the first fluid guide 51, for a fluid flow that is separated from the first fluid guide 51. Via the second feed opening 520, inflowing fluid passes into a guide duct 522 of the second fluid guide 52, which guide duct extends in the first, static part 55 likewise axially but so as to be offset in a circumferential direction with respect to a guide duct 512 of the first fluid guide 51. Here, a guide duct 522 of the second fluid guide 52 opens into an outflow opening 521. This outflow opening 521 of the second fluid guide 52 is offset axially, and in a circumferential direction about the rotation axis of the second, rotating part 56, with respect to an outflow opening 511 of the first fluid guide 51. Via the outflow opening 521 of the second fluid guide 52, the oil passes via a duct portion 560B, which is open towards the first, static part 55, to the second supply line 5B. A seal at the transition between the outflow opening 521 of the second fluid guide 52 and the duct portion 560B of the second supply line 5B is realized here likewise by means of two seals 50b, 50c, for example each in the form of sealing rings. Here, a seal 50b is consequently provided axially between the outflow openings 511 and 521 of the first and second fluid guides 51, 52. In principle, a construction with two central seals 50b may also be provided in order to reliably rule out leakage from one transition into the other.

Owing to the spatial separation of fluid flows to the different supply lines 5A and 5B that is realized by means of the feed device 5, it is possible in particular for oil at different temperatures to be supplied to the supply lines 5A and 5B for different regions in the planetary gear box 30. This encompasses in particular the possibility whereby relatively cool fluid is provided to the first supply line 5A for the plain bearing. Thus, during the operation of the gas turbine engine 10, a greater expansion of the planet gear 23 in relation to the bearing journal 61 of the plain bearing is intentionally allowed in order to provide a larger fluid gap at the plain bearing for a more stable lubricating (plain bearing) film. The proposed solution is however self-evidently not restricted to this. The independence of the fluid flow in the feed device 5 for the two supply lines 5A and 5B (or other supply lines) may self-evidently also be utilized in some other way.

FIG. 3 shows, in an exploded illustration, a structural design of the feed device 5 corresponding to FIGS. 1 and 2 with further details. Here, the feed device 5 is of multi-part form and, aside from a housing part 5.1, on which the first and second feed openings 510 and 520 are provided, comprises a distributor component 5.2 and a guide duct component 5.3. The distributor component is configured as a distributor pipe 5.2, which is at least partially received in the sleeve-shaped housing part 5.1 of the feed device 5. The guide duct component is in turn configured as an internally situated transfer pipe piece 5.3, which is received in the distributor pipe 5.2.

Via a feed opening 510 or 520, which is accessible radially from the outside, of the housing part 5.1, fluid—in this case oil—can flow into a distributor duct which is formed, for a respective fluid guide 51, 52 of the feed device 5, between an inner lateral surface of the housing part 5.1 and an outer lateral surface of the distributor pipe 5.2 and is sealed off axially to both sides. Fluid flowing in via a feed opening 510 or 520 can thus flow into the respective circumferentially encircling distributor duct. Via distributor openings 510A or 520A in the distributor pipe 5.2, the fluid can then flow in targeted fashion out of the respective distributor duct into guide ducts 511 and 512, which are formed on the inner transfer pipe piece 5.3.

The guide ducts 512 and 522 that are assigned to the different fluid guides 51 and 52 are (depending on which fluid guide 51 or 52 they are assigned to) formed over different lengths on an outer lateral surface of the inner transfer pipe piece 5.3. Thus, in the respective guide duct 512, 522, the fluid can flow over a defined flow path along an outer lateral surface of the inner transfer pipe piece 5.3. A fluid flow from one distributor duct is thus divided up into a multiplicity of partial fluid flows in guide ducts 512 or 522. A first type of fluid duct 512 is always only part of the first fluid guide 51 and thus assigned only to exactly one of the two distributor ducts. Likewise, a second type of fluid duct 522 is only part of the second fluid guide 52 and thus assigned to the other distributor duct.

The different types of fluid ducts are in the present case arranged so as to be distributed, in alternation with one another, over the outer circumference of the inner transfer pipe piece 5.3. Outflow openings 511 and 521 are additionally formed on the distributor pipe 5.2 downstream of the distributor openings 510A and 520A in relation to the respective partial fluid flow in a guide duct 512, 522. Here, a first set of outflow openings 511 opens into a duct, which is designed in the manner of a circumferential channel, on the distributor pipe 5.2, whilst a further duct is formed axially offset with respect to this on the distributor pipe 5.2, into which further duct a second set of outlet openings 521 opens. Owing to the different lengths of the guide ducts 512, 522, the outflow openings 511 are assigned to the guide ducts 512 of the first fluid guide 51, whilst the outflow openings 521, which are respectively axially offset with respect thereto, are assigned to the fluid ducts 522 of the second fluid guide 52. The outflow openings 511 and 521 of the different fluid guides 51 and 52 are furthermore offset with respect to one another in a circumferential direction on the distributor pipe 5.2, such that each guide duct 512 or 522 is assigned exactly one outflow opening 511 or 521 in the distributor pipe 5.2, and accordingly, a partial fluid flow from the respective guide duct 512 or 522 can flow radially outward only via the associated outflow opening 511 or 521 and then onward via the latter to the respectively associated duct portion 560A or 560B of the first or second supply line 5A, 5B.

In the design variant illustrated in FIG. 3, the distributor pipe 5.2 has exactly six distributor openings 510A or 520A for each fluid guide 51, 52, which distributor openings are arranged so as to be distributed uniformly over the circumference of the distributor pipe 5.2 in the respective distributor duct. In turn, only exactly one feed opening 510 or 520 is provided for each fluid guide 51 or 52 on the housing 5.1.

Instead of a multi-part feed device 5 with a housing part 5.1 and a distributor pipe 5.2 for dividing up the different fluid flows into a multiplicity of partial fluid flows in the direction of an associated first or second supply line 5A, 5B, the design variant of FIGS. 4A, 4B and 5 provides a single-piece form of the feed device 5 with a guide duct component 5.3* which incorporates not only the guide ducts 512 and 522 for the first and second fluid guides 51 and 52 but also the feed openings 510, 520 and the outflow openings 511, 521.

The guide duct component 5.3* illustrated in FIGS. 4A, 4B and 5 may be a component manufactured by additive processes. By means of an additive manufacturing process, it is for example also readily possible to form the feed openings 510 and 520 for the different fluid guides 51 and 52 without an axial offset with respect to one another on the guide duct component 5.3*. Here, a first feed opening 510 of the first fluid guide 51 is thus arranged so as to be offset with respect to a second feed opening 520 of the second fluid guide 52 only in a circumferential direction U (about the rotation axis of the second, rotating part 56), whereby the guide duct component 5.3* is made shorter in an axial direction. An offset may for example be 90°, correspondingly to the cross-sectional view in FIG. 5, such that two diametrically mutually oppositely situated first feed openings 510 to guide ducts 512 of a first fluid guide and two diametrically mutually oppositely situated second feed openings 520 to a respective guide duct 522 of a second fluid guide 52 are ultimately provided on a circumference of the fluid duct component 5.3*.

The guide ducts 512 and 522, which in the present case each extend over a circular ring segment in cross section, of a guide duct component 5.3* open in each case into an associated outflow opening 511 or 521. The outflow openings 511 and 521 are again arranged axially offset with respect to one another. Accordingly, in this design variant, too, the guide ducts 512, 522 are of different lengths in an axial direction in a manner dependent on whether the respective guide duct is a (first) guide duct 512 of the first fluid guide 51 or a (second) guide duct 522 of the second fluid guide 52.

The guide duct component 5.3*, manufactured by additive processes, of FIGS. 4A, 4B and 5 furthermore also incorporates circumferentially encircling grooves 500a, 500b and 500c, which are provided for the seals 50a, 50b and 50c. The seals 50a, 50b and 50c of the design variants of FIGS. 1, 2 and 3 are also received in corresponding grooves. These are however not illustrated in detail in FIGS. 1, 2 and 3.

By means of the different fluid guides 51 and 52 that are fluidically connected to different supply lines 5A and 5B for different regions of the planetary gear box 30, it is possible for specifically adapted fluid flows, in particular fluid flows that differ from one another in terms of their temperature, to be established at the respective region, which is to be lubricated and/or cooled, of the planetary gear box 30. This allows not only a flexibilization with regard to the conveyance of oil within the planetary gear box 30 but also a reduction in weight of the gear box assembly, because, in the event of doubt, it is also possible at least for one region to allow a higher temperature of the oil that is to be conveyed, which in turn allows the use of a smaller and therefore more lightweight oil cooler.

It is self-evident that the invention is not limited to the embodiments described above, and various modifications and improvements can be made without departing from the concepts described herein. Any of the features may be used separately or in combination with any other features, unless they are mutually exclusive, and the disclosure extends to and includes all combinations and subcombinations of one or more features that are described herein.

### LIST OF REFERENCE DESIGNATIONS

9 Main rotation axis
10 Gas turbine engine
11 Core engine
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass duct
23 Fan
24 Stationary support structure
26 Shaft
27 Connecting shaft
28 Sun gear
30 (Planetary) gear box
32 Planet gears
325 Nozzle holder
34 Planet carrier
36 Linkage
38 Ring gear
40 Linkage
5 Feed device
5A, 5B First/second supply line
50a, 50b, 50c Seal
500a/b/c Groove
51 First fluid guide
510 Feed opening
510a Distributor opening
511 Outflow opening
512 Guide duct
52 Second fluid guide
520 Feed opening
520a Distributor opening
521 Outflow opening
522 Guide duct
55 Static part
56 Rotating part
560A/B Duct portion
5.1 Housing part
5.2 Distributor pipe (distributor component)
5.3 Inner transfer pipe piece (guide duct component)
5.3* Guide duct component manufactured by additive processes
60 Drive shaft
61 Journal for planet gear
A Core air flow
B Bypass air flow

1. A gear box assembly for an engine, having
a gear box for transmitting a torque,
at least one first, static part,
at least one second, rotating part, which is mounted so as to be rotatable relative to the first, static part and on which at least one element of the gear box is provided, and
a conduit system for conveying a fluid to at least two different regions of the gear box,
wherein the conduit system has at least one first supply line in the second, rotating part for the purposes of conveying fluid to a first region of the gear box and has at least one second supply line in the second, rotating part for the purposes of conveying fluid to a second region of the gear box, and
wherein the conduit system has a feed device in the first, static part, by means of which feed device fluid can be guided to the first supply line and to the second supply line,
wherein
the feed device has at least two separate fluid guides, of which a first fluid guide is provided for guiding fluid from at least one first feed opening to the first supply line and a second fluid guide is provided for guiding fluid from at least one second feed opening to the second supply line.

2. The gear box assembly according to claim 1, wherein the at least two fluid guides are provided for guiding a fluid with different delivery pressures, speeds and/or temperatures.

3. The gear box assembly according to claim 1, wherein each fluid guide has at least one guide duct for the fluid that is to be guided to the respective supply line.

4. The gear box assembly according to claim 3, wherein the at least one guide duct extends in each case axially in relation to a rotation axis of the second, rotating part.

5. The gear box assembly according to claim 3, wherein a guide duct of the first fluid guide and a guide duct of the second fluid guide have different lengths.

6. The gear box assembly according to claim 3, wherein the feed device has a feed duct component on which both at least one guide duct of the first fluid guide and at least one guide duct of the second fluid guide are formed.

7. The gear box assembly according to claim 6, wherein the guide ducts of the at least two different fluid guides are arranged so as to alternate with one another along a circumferential direction on the guide duct component.

8. The gear box assembly according to claim 3, wherein the first fluid guide has at least two guide ducts to which the at least one first feed opening is assigned, and/or the second fluid guide has at least two guide ducts to which the at least one second feed opening is assigned.

9. The gear box assembly according to claim 8, wherein the feed device comprises a distributor component by means of which a fluid flow from the at least one first feed opening and/or a fluid flow from the at least one second feed opening can be divided up into multiple partial flows to the assigned guide ducts.

10. The gear box assembly according to claim 9, wherein the distributor component has at least two distributor openings by means of which fluid from a fluid flow can be guided to the at least two guide ducts.

11. The gear box assembly according to claim 10, wherein the feed device comprises a housing part on which the at least one first feed opening is provided and which, together with the distributor component, defines a distributor duct which runs in circumferentially encircling fashion in relation to the rotation axis of the second, rotating part and into which fluid can flow from the at least one first feed opening and from which the inflowing fluid can flow via the at least two distributor openings into the at least two guide ducts of the first fluid guide.

12. The gear box assembly according to claim 9, wherein, on the distributor component, there is provided at least one outflow opening via which fluid can flow from the respective guide duct to the assigned first or second supply line.

13. The gear box assembly according to claim 3, wherein a guide duct of a fluid guide is assigned exactly one feed opening.

14. The gear box assembly according to claim 3, wherein a guide duct is assigned in each case one outflow opening of the feed device, via which fluid can flow from the respective guide duct to the assigned first or second supply line.

15. The gear box assembly according to claim 14, wherein an outflow opening of the first fluid guide is axially offset with respect to an outflow opening of the second fluid guide in relation to the rotation axis of the second, rotating part.

16. The gear box assembly according to claim 1, wherein the first feed opening and the second feed opening are positioned offset with respect to one another axially, and/or in a circumferential direction, in relation to the rotation axis of the second, rotating part.

17. The gear box assembly according to claim 1, wherein the first supply line is provided for conveying the fluid to a bearing of the gear box and the second supply line is provided for conveying the fluid to a toothed gear pairing of the gear box.

18. The gear box assembly according to claim 17, wherein the first supply line is provided for conveying fluid to a plain bearing of the planet gear, which fluid is cooler than the fluid for the toothed gear pairing.

19. The gear box assembly according to claim 1, wherein the gear box is configured as a planetary gear box.

20. The gear box assembly according to claim 19, wherein the conduit system is part of an oil supply for a planet carrier of the planetary gear box.

21. The gear box assembly according to claim 17, wherein the first supply line is provided for conveying the fluid to a bearing by means of which a planet gear of the planetary gear box is rotatably mounted on the planet carrier, and the second supply line is provided for conveying the fluid to a toothed gear pairing between a planet gear and a sun gear of the planetary gear box.

22. An engine having a gear box assembly according to claim 1.

23. The engine according to claim 22, which at least comprises:
a core engine that comprises a turbine, a compressor, and a core shaft connecting the turbine to the compressor, and
a fan that is positioned upstream of the core engine, wherein the fan comprises a plurality of fan blades,
wherein the gear box of the gear box assembly can be driven by the core shaft, and the fan can be driven at a lower rotational speed than the core shaft by means of the gear box.
